(19) United States
(12) Patent Application Publication
(10) Pub. No.: US 2003/0182193 A1
(43) Pub. Date: Sep. 25, 2003

(54) Method of and device for shelf inventory tracking, and computer product

(75) Inventor: Hiroshi Kawamata, Tokyo (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/260,561

(22) Filed: Oct. 1, 2002

(30) Foreign Application Priority Data
Mar. 25, 2002 (JP) 2002-084094

(51) Int. Cl. G06F 17/60

(52) U.S. Cl. 705/16

(57) ABSTRACT

Information about a product is recorded in a tag, and the tag is attached to the corresponding product. When performing inventory tracking of a shelf on which many such products are displayed, the information in the tag is read and the quantity of products is decided from the read information.

### BACKGROUND OF THE INVENTION

1) Field of the Invention

The present invention relates to a technology capable of rapidly and accurately performing tracking inventory.

2) Description of the Related Art

Conventionally, in a store or shop, inventory tracking of products displayed on shelves is performed manually. For example, a salesclerk scans the barcodes attached to the products using a handy terminal to perform the inventory tracking. Moreover, the salesclerk will count the products displayed on the shelves to determine the quantity of unsold products.

As the inventory tracking is performed manually by scanning the barcode attached to each product, there is a problem that a lot of time and labor is required. The required time and labor shall increase as the number of the products increases. Particularly, in large-scale stores where a large number of products are handled, a lot of time and labor is spent in inventory tracking and it leads to increased personnel costs.

In addition, conventionally there is a problem that, since the salesclerks count the products for determining the quantity the operation takes lot of time and there is a great possibility of miscounting.

### SUMMARY OF THE INVENTION

It is an object of the present invention to provide a shelf inventory tracking device, a shelf inventory tracking method, and a computer program capable of rapidly and accurately tracking inventory.

In the device and the method according to the present invention, information about a product is recorded in a tag, and the tag is attached to that product. When performing inventory tracking of the shelf on which different such products are displayed, the information in the tag is read and the quantity of products is decided from the read information.

The computer-readable recording medium according to the present invention stores therein a computer program which realizes the method according to the present invention on a computer.

These and other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a block diagram which shows a configuration of an embodiment according to the present invention,

FIG. 2 is a plan view which shows a shelf arrangement in a store 900 of the embodiment,

FIG. 3 is a diagram which shows a table configuration of a product information database 305 shown in FIG. 1,

FIG. 4 is a diagram which shows a table configuration of a shelf management information database 306 shown in FIG. 1,

FIG. 5 is a plan view which shows a configuration of a shelf R1-1 shown in FIG. 2,

FIG. 6 is a diagram which shows an appearance of an electronic shelf tag 500₁ shown in FIG. 5,

FIG. 7 is a block diagram which shows an electrical configuration of the electronic shelf tag 500₁ shown in FIG. 6,

FIG. 8 is a block diagram which shows configurations of a super tag 700₁ and a tag reader 800₁ shown in FIG. 5,

FIG. 9 is a diagram which shows super tag data 710 used in the embodiment,

FIG. 10 is a flow chart which describes an operation of the embodiment,

FIG. 11 is a flow chart which describes a product name-price display processing shown in FIG. 10,

FIG. 12 is a flow chart which describes an inventory tracking processing for each electronic shelf tag shown in FIG. 10,

FIG. 13 is a diagram which shows an initial screen 1000 in the embodiment,

FIG. 14 is a diagram which shows a planogram display screen 1100 in the embodiment,

FIG. 15 is a diagram which shows an inventory tracking result for each electronic shelf tag in the embodiment, and

FIG. 16 is a block diagram which shows a configuration of a modification of the embodiment.

### DETAILED DESCRIPTIONS

Embodiment(s) of the shelf inventory tracking device, the shelf inventory tracking method, and the shelf inventory tracking program according to the present invention will be described in detail with reference to the accompanying drawings.

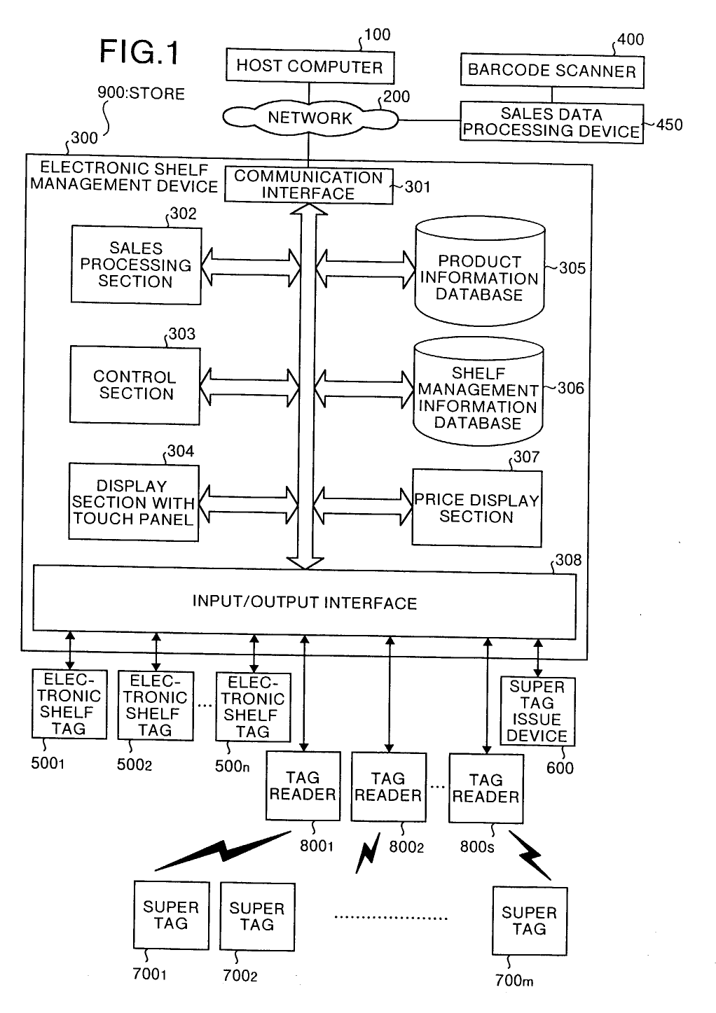

FIG. 1 is a block diagram which shows a configuration of an embodiment according to the present invention. A host computer 100 is, for example, a computer device provided at the side of a franchiser that manages a chain of franchise stores 900. An electronic shelf management device 300 is provided in each franchise store 900. The host computer 100 is capable of communicating with the electronic shelf management device 300 via a network 200. This host computer 100 receives sales data and the like of franchise store from the electronic shelf management device 300.

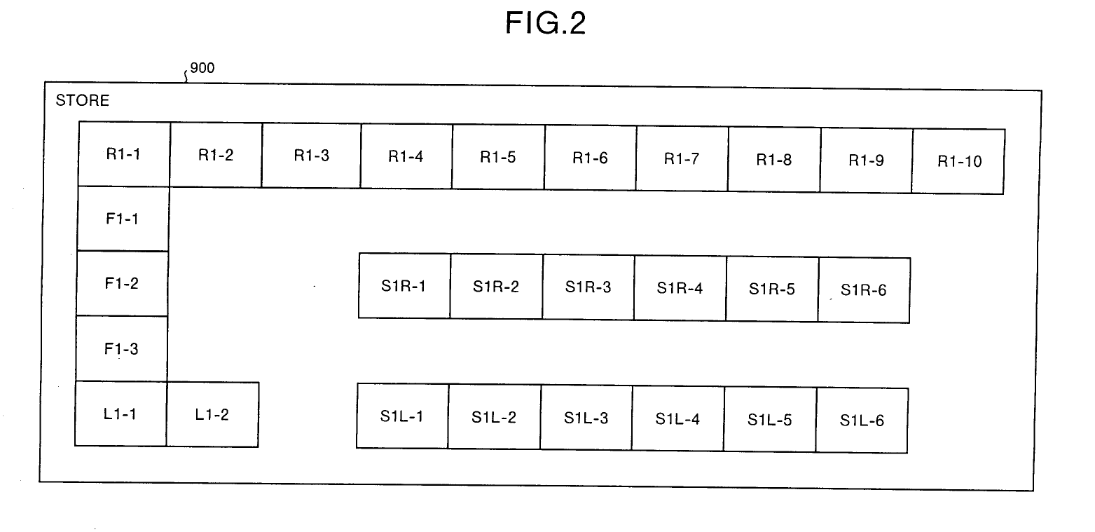

FIG. 2 shows an example of arrangement of products in on a shelf (shelf arrangement) in the franchise store 900. The franchise store 900 has shelves R1-1 through R1-10, F1-1 through F1-3, L1-1, L1-2, S1R-1 through S1R-6, and S1L-1 through S1L-6. Each shelf has many compartments (stages) FIG. 2 shows only a plan view of a first stage.

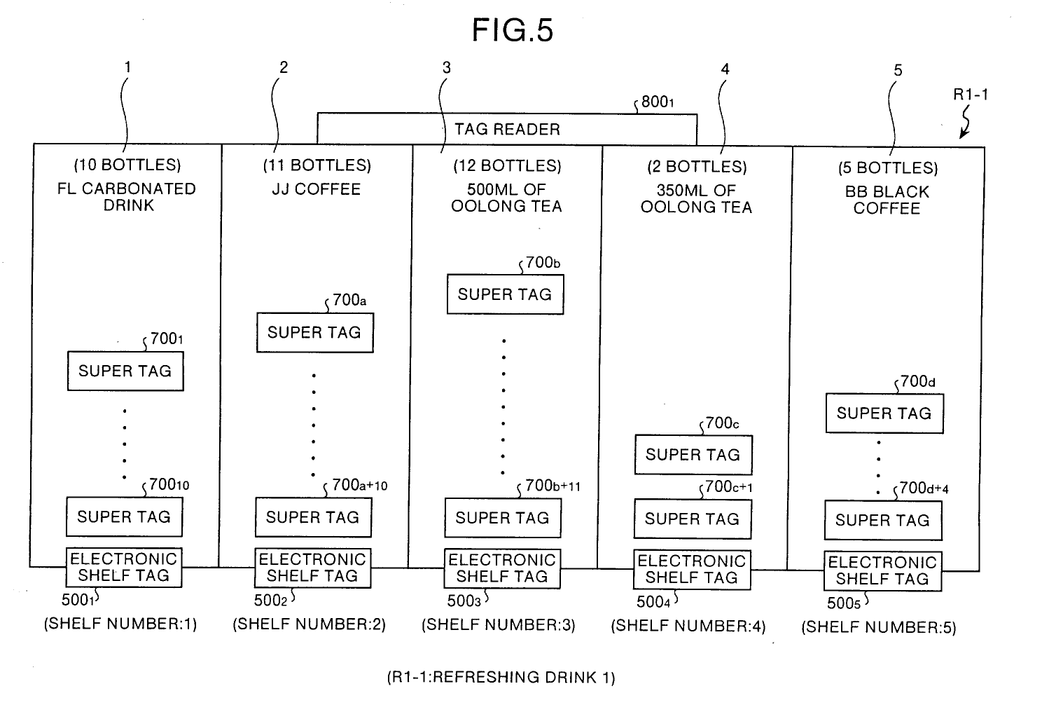

For example, refreshing drinks such as FJ carbonated drinks, JJ coffee, oolong tea (see FIG. 5) are displayed on the shelf R1-1. In this case, the term refreshing drink shall be the representative product name. In the similar manner, the other shelves shall also have some different product name and an appropriate representative product name. In the following explanation, the reference numeral, for example, R1-1 provided to the shelf may also be called as a shelf major division number.

FIG. 5 shows a plan view of the shelf R1-1. The shelf R1-1 is divided into five vertical divisions 1 to 5. For example, bottles of FJ carbonated drink are arranged in the division 1, bottles of JJ coffee are arranged in the division 2, 500-ml bottles of oolong tea are arranged in the division 3, 350-ml bottles of oolong tea are arranged in the division 4, and bottles of BB black coffee are arranged in the division 5. In the following explanation, the reference numeral, for example, 1 provided to the vertical division of the shelf may also be called as a division number.

The electronic shelf management device 300 (see FIG. 1) performs sales management of products displayed on the respective shelves, tracks inventory of products, a display control of electronic shelf tags 500₁ to 500ₙ, and drive-controlling of tag readers 800₁ to 800ₛ. A detail explanation about the electronic shelf tags 500₁ to 500ₙ and the tag readers 800₁ to 800ₛ will be given at a later stage.

In the electronic shelf management device 300, a communication interface 301 controls the communication with the host computer 100 via the network 200 according to a predetermined communication protocol. A sales processing section 302 comprises a function for summing up sales data transmitted from a sales data processing device 450 when a product is sold and transmitting it to the host computer 100, and the like.

A control section 303 is directed for controlling respective sections of the device. Details of operations of this control section 303 will be described later. A display section with touch panel 304 is configured so that a pressure-sensitive touch panel is attached to the surface of a display, and comprises a function for displaying a menu screen and the like for salesclerks, and a key function through the touch panel.

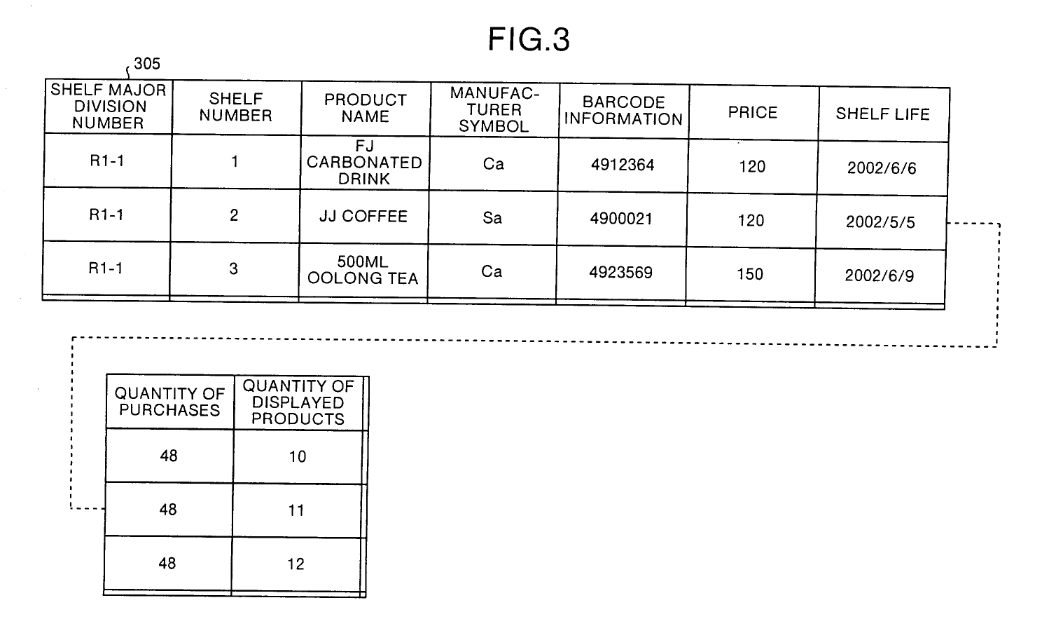

A product information database 305 is a database for having product information with respect to products sold in franchise store (refer to FIG. 2) stored therein. Specifically, as shown in FIG. 3, the product information database 305 comprises fields such as “shelf major division number”, “shelf number”, “product name”, “manufacturer symbol”, “barcode information”, “price”, “shelf life”, “quantity of purchases”, “quantity of displayed products”, and the like.

The “shelf major division number” corresponds to each of the shelves R1-1, R1-2, . . . , S1L-6 shown in FIG. 2, respectively. The “shelf numbers” correspond to the shelves 1, . . . , shown in FIG. 5, respectively. The “product name” is a name of a product. The “manufacturer symbol” is a symbol indicating a manufacturer of the product.

The “barcode information” is information on a barcode attached to the product. The “price” is a sales price of the product. The “shelf life” is data on the shelf life of the product. The “quantity of purchases” is the quantity of the products stocked by franchise store. The “quantity of displayed products” is the quantity of the products displayed on the shelves.

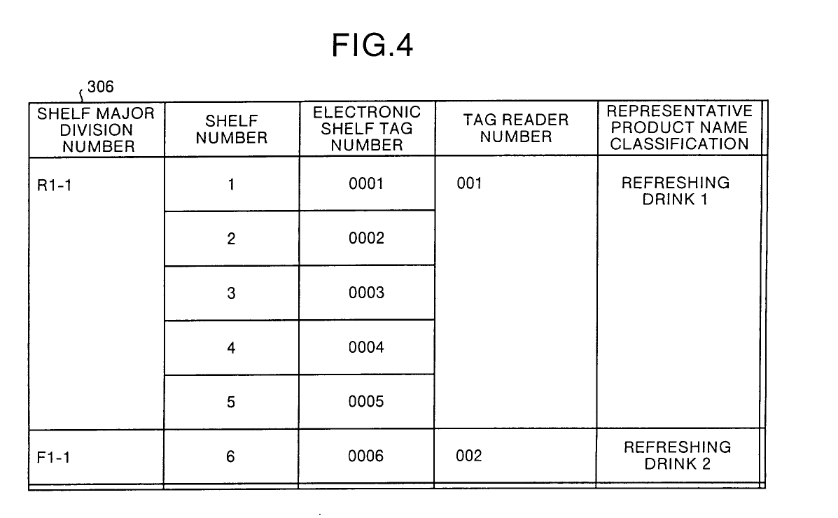

A shelf management information database 306 (see FIG. 1) is a database which stores therein shelf management information for managing the respective shelves in franchise store 900. Specifically, as shown in FIG. 4, the shelf management information database 306 comprises fields such as “shelf major division number”, “shelf number”, “electronic shelf tag number”, “tag reader number”, “representative product name classification”, and the like.

The “shelf major division number” and the “shelf number” correspond to the “shelf major division number” and the “shelf number” shown in FIG. 3. The “electronic shelf tag number” is a number for identifying electronic shelf tags 500₁ to 500ₙ (refer to FIG. 1) described later. The “tag reader number” is a number for identifying tag readers 800₁ to 800ₛ described later. The “representative product name classification” is a classification of a plurality of products displayed on the shelf corresponding to the shelf major division number.

A price display section 307 (see FIG. 1) displays the product information on the electronic shelf tags on the basis of the shelf management information database 306 and the product information database 305. An input/output interface 308 establishes interfaces between the sales processing section 302, the control section 303, and another group of the electronic shelf tags 500₁ to 500ₙ, a super tag issue device 600 and the tag readers 800₁ to 800ₛ.

A barcode scanner 400 is a device which optically reads out barcode information attached to a product, and is connected to the sales data processing device 450. The sales data processing device 450 processes sales data on the basis of the barcode information from the barcode scanner 400. The electronic shelf tags 500₁ to 500ₙ are arranged on respective shelves, and each tag comprises a function for electronically displaying the product name, the price, the quantity of stocked products, the quantity of products displayed on the shelf and the like, a function for performing inventory tracking instruction, and the like. Unique electronic shelf tag numbers (refer to FIG. 4) are attached to these electronic shelf tags 500₁ to 500ₙ, respectively.

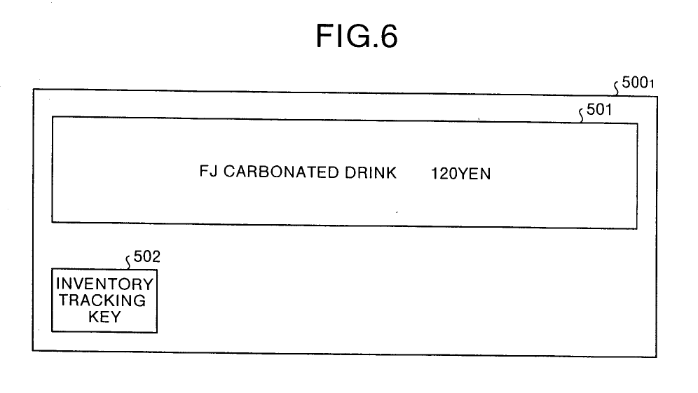

For example, among the electronic shelf tags 500₁ to 500ₙ, as shown in FIG. 5, the electronic shelf tags 500₁ to 500₅ are provided on the aisle sides of the shelves 1 to 5, respectively. FIG. 6 is a diagram which shows an appearance of the electronic shelf tag 500₁ shown in FIG. 5.

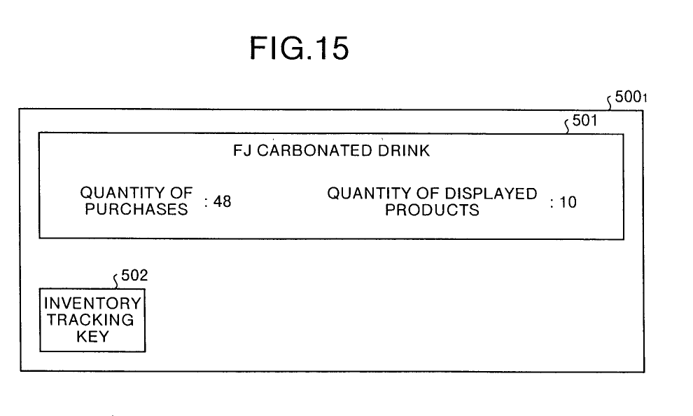

A display section 501 is displayed and controlled by the control section 303 and the price display section 307. In this display section 501, the product name (FJ carbonated drink) of the product displayed on the shelf 1 is displayed, the price (120 yen), the quantity of stocked products (48) shown in FIG. 15 at the inventory tracking, the quantity of displayed products (15), and the like. An inventory tracking key 502 is a key for performing inventory tracking of products displayed on the shelves. The inventory tracking includes confirmation of the product names of the products and the quantity of displayed products, comparison of the quantity of purchases and the quantity of displayed products, and the like.

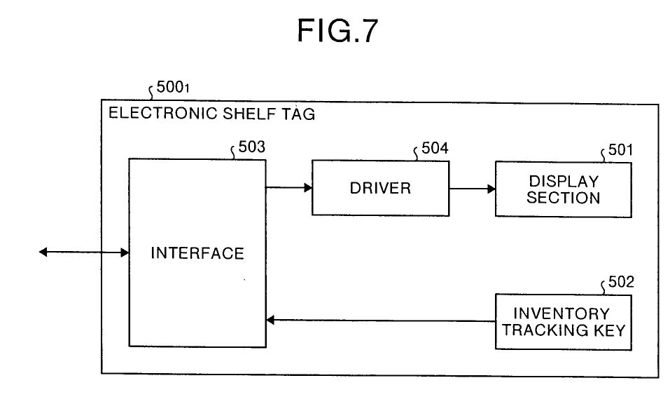

FIG. 7 is a block diagram which shows an electrical configuration of the electronic shelf tag 500₁ shown in FIG. 6. In this drawing, like reference numerals are denoted to parts corresponding to those in FIG. 6, and description thereof will be omitted. An interface 503 shown in the drawing is connected to the input/output interface 308 (refer to FIG. 1). A driver 504 drives the display section 501 under control of the control section 303 (refer to FIG. 1) and the price display section 307. The electronic shelf tags 500₂ to 500ₙ shown in FIG. 1 have the same configuration as that of the aforementioned electronic shelf tag 500₁.

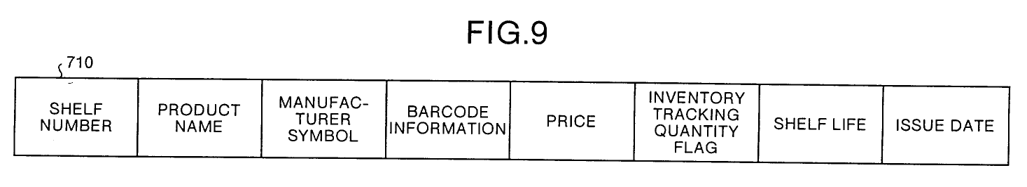

The super tag issue device 600 is a device for issuing super tags 700₁ to 700ₘ. Theses super tags 700₁ to 700ₘ are tags attached to the respective products, and super tag data 710 shown in FIG. 9 is read out via a wireless link by the tag readers 800₁ to 800ₙ described later.

The super tag data 710 is configured with the product information on corresponding products, and the like.

Specifically, in the super tag data 710, a shelf number, a product name, a manufacturer symbol, barcode information, a price and a shelf life correspond to the shelf number, the product name, the price, the manufacturer symbol, the barcode information, the price, and the shelf life shown in FIG. 3. An inventory tracking quantity flag is a flag used for counting the quantity of products. An issue date is a date on which a super tag is issued by the super tag issue device 600.

In the shelf 1 shown in FIG. 5, 10 bottles of FJ carbonated drink are displayed and the super tags 700₁ to 700₁₀ are attached to the respective products. In the shelf 2, 11 bottles of JJ coffee are displayed and the super tags 700ₐ to 700ₐ₊₁₀ are attached to the respective products.

In the shelf 3, twelve 500 ml-bottles of oolong tea are displayed and the super tags 700_{b} to 700_{b+11} are attached to the respective products. In the shelf 4, 2 350 ml-bottles of oolong tea are displayed and the super tags 700_{c} to 700_{c+1} are attached to the respective products.

In the shelf 5, 5 bottles of BB black coffee are displayed and the super tags 700_{d} to 700_{d+4} are attached to the respective products. Hereinafter, in a similar manner, products with super tag are displayed on each shelf (not shown).

The tag reader 800₁ reads out the super tag data from the super tags 700₁ to 700_{d+4} of the respective products displayed on the shelf R1-1 (shelves 1 to 5). Other tag readers 800₂ to 800ₛ are provided on the shelf R1-2 to the shelf S1L-6 shown in FIG. 2 in a correspondence manner, and read out the super tag data from the respective super tags.

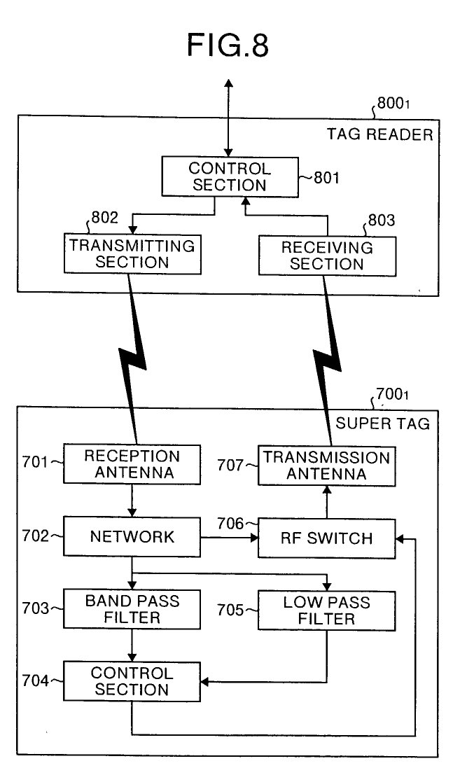

FIG. 8 is a block diagram which shows configurations of the super tag 700₁ and the tag reader 800₁ shown in FIG. 5. In the tag reader 800₁ shown in this figure, a control section 801 controls respective sections. A transmitting section 802 transmits a signal having a frequency component specific to the super tag (super tag 700₁ in this figure). A receiving section 803 receives and demodulates a signal returned from the super tag 700₁, and reads out the super tag data 710 (refer to FIG. 9) included in the reception signal. The tag reader 800₁ comprises a function for performing transmission/reception of signals in a time division multiple access manner for each of the plurality of super tags.

On the other hand, in the super tag 700₁, a reception antenna 701 is an antenna for receiving a signal from the tag reader 800₁. A network 702 outputs a signal input via the reception antenna 701 to a band pass filter 703 and a low pass filter 705 at a downstream stage, and outputs harmonic of three times the signal to a RF switch 706.

The low pass filter 705 passes a low frequency component in the signal from the network 702 to output it to a control section 704 at the downstream stage. This low frequency component is supplied as an electromotive force to the control section 704. The band pass filter 703 passes a desired band component in the signal from the network 702 to output it to the control section 704 at the downstream stage.

The super tag data 710 (refer to FIG. 9) is stored in the control section 704. This control section 704 controls transmitting of the super tag data 710 to the tag reader 800₁ via the RF switch 706 and a transmission antenna 707 on the basis of the band component from the band pass filter 703.

The RF switch 706 is configured such that the signal from the network 702 and the super tag data 710 are transmitted to the transmission antenna 707 while a high level control signal is being input from the control section 704, on the other hand, the signal from the network 702 and the super tag data 710 are not transmitted when a low level control signal is input. The super tags 700₂ to 700ₘ and the tag readers 800₂ to 800ₛ shown in FIG. 1 have the same configurations as those of the aforementioned super tag 700₁ and tag reader 800₁.

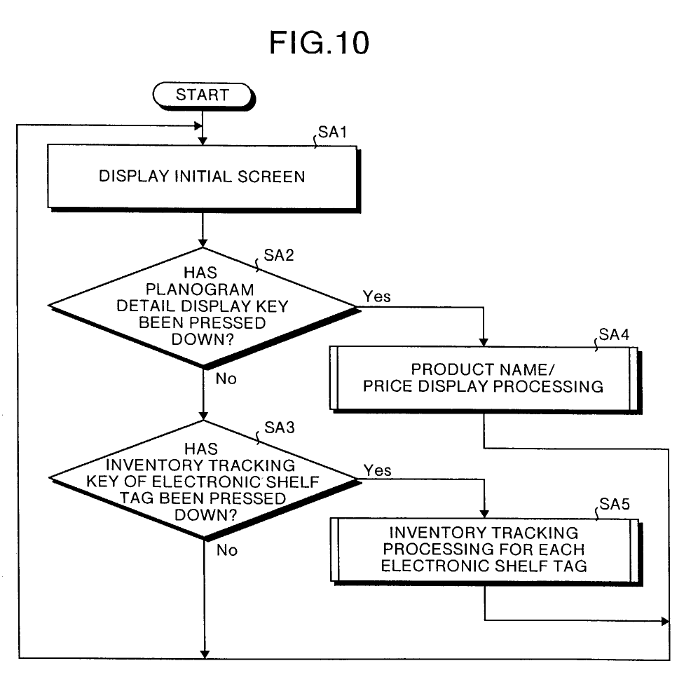

Operations of the embodiment will be described in detail with reference to the flow charts shown in FIGS. 10 to 12 and FIGS. 13 to 15.

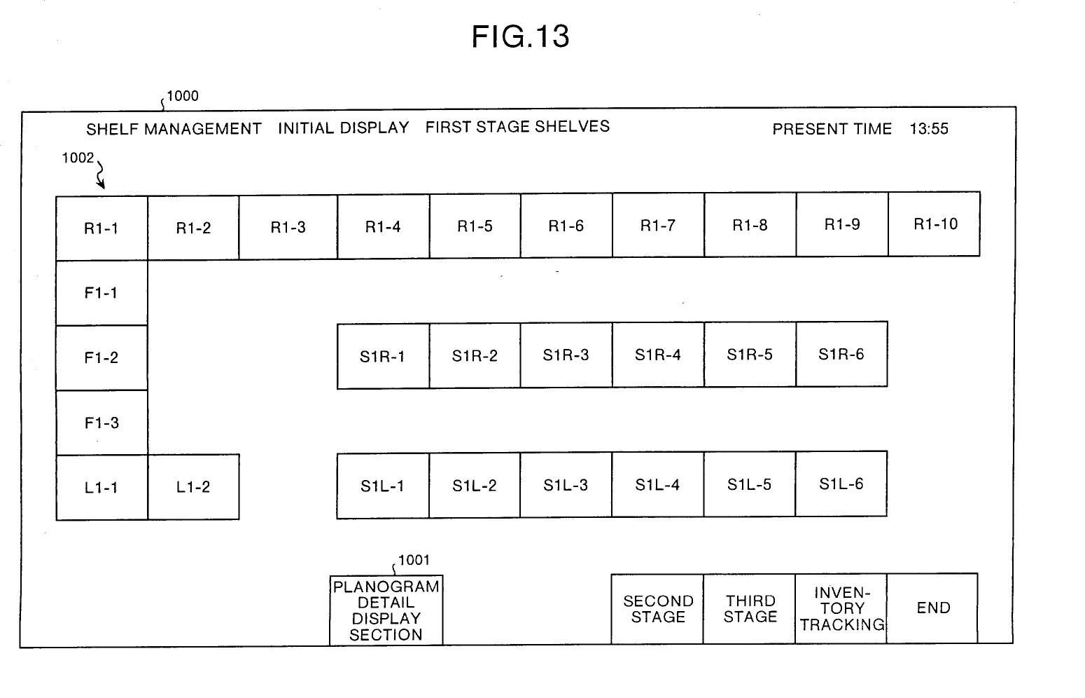

In step SA1 shown in FIG. 10, the control section 303 of the electronic shelf management device 300 causes the display section with touch panel 304 to display an initial screen 1000 shown in FIG. 13. In this initial screen 1000, a planogram detail display key 1001 is a key for displaying details of the planogram. A shelf arrangement diagram 1002 corresponds to the shelf arrangement in franchise store 900. In step SA2, the control section 303 determines whether or not the planogram detail display key 1001 has been pressed down. In this case, a determination result is set to “No”.

In step SA3, the control section 303 determines whether or not the inventory tracking key (for example, the inventory tracking key 502 in FIG. 6) of any one of the electronic shelf tags 500₁ to 500ₙ has been pressed down by a salesclerk. In this case, a determination result is set to “No” and step SA1 to step SA3 are repeated.

When the planogram detail display key 1001 shown in FIG. 15 is pressed down, the control section 303 sets the determination result in step SA2 to “Yes”. In step SA4, the control section 303 and the price display section 307 perform a product name-price display processing for displaying product name-price of the product on the electronic shelf tag.

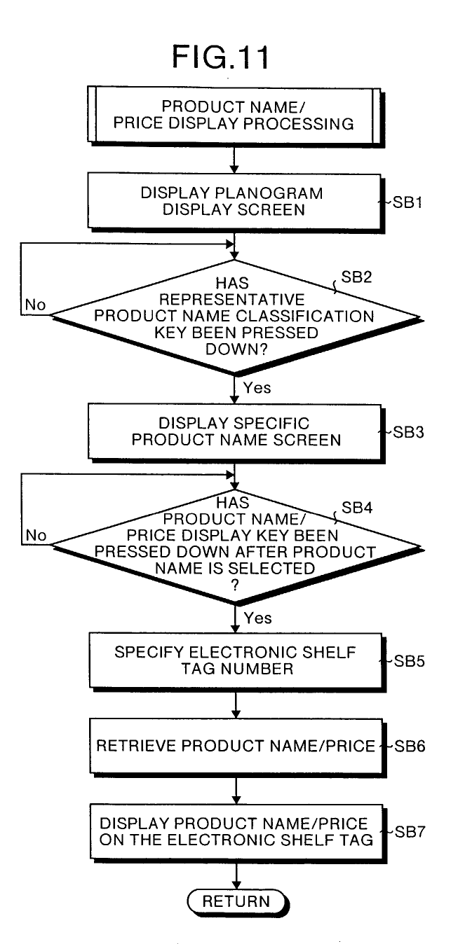

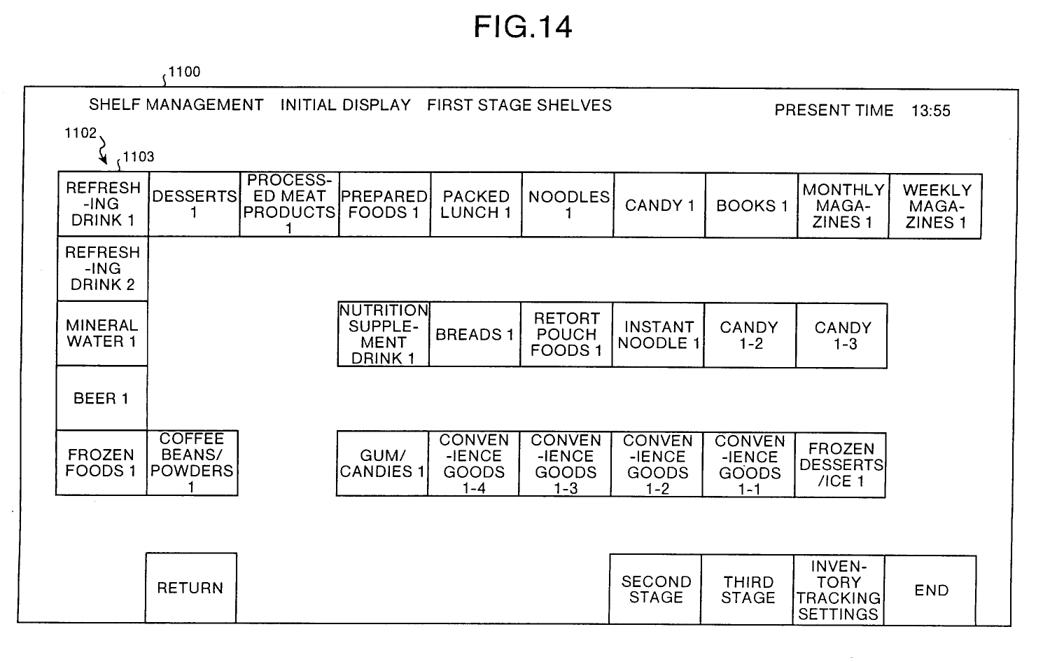

Specifically, in step SB1 shown in FIG. 11, the control section 303 causes the display section with touch panel 304 to display the planogram display screen 1100 shown in FIG. 14 on the basis of the planogram data from the shelf management information database 306.

A planogram detail diagram 1101 corresponds to the shelf arrangement diagram 1002 shown in FIG. 13. In each block of the planogram detail diagram 1101, the representative product name classification on the basis of the shelf management information of the shelf management information database 306 (refer to FIG. 4) is displayed. For example, a refreshing drink 1 shown in FIG. 14 is allocated to the shelf R1-1 shown in FIG. 13. Each block of the planogram detail diagram 1102 is set as a representative product name classification key.

In step SB2 shown in FIG. 11, the control section 303 determines whether or not the representative product name classification key in the planogram detail diagram 1101 has been pressed down. In this case, a determination result is set to “No”, and the determination is repeated. When the representative product name classification key 1102 (refreshing drink 1) shown in FIG. 14 is pressed down by a salesclerk, the control section 303 sets the determination result in step SB2 to “Yes”.

In step SB3, the control section 303 retrieves the shelf number, the product name, the barcode information, and the manufacturer symbol from the product information database 305 shown in FIG. 3 with the shelf major division number (R1-1) corresponding to the representative product name classification key 1102 as the key. The control section 303 causes the display section with touch panel 304 to display a retrieval result as a specific product name screen (not shown).

In this specific product name screen, specific product name data as the above retrieval result or the product name-price display key for displaying product name-price on the electronic shelf tag is displayed. In step SB4 shown in FIG. 11, the control section 303 determines whether or not the product name-price display key has been pressed down by a salesclerk after a product name is selected from the specific product name data. In this case, a determination result is set to “No” and the determination is repeated.

When the product name-price display key is pressed down by a salesclerk after, for example, a FJ carbonated drink is selected from the specific product name data, the control section 303 sets the determination result in step SB4 to “Yes”. In step SB5, the control section 303 specifies an electronic shelf tag number 0001 with the shelf number 1 (refer to FIG. 4) corresponding to the selected FJ carbonated drink as the key.

In step SB6, the price display section 307 retrieves the product name-price (FJ carbonated drink and 120 yen) from the product information database 305 shown in FIG. 3 with the above shelf number as the key. In step SB7, the price display section 307 displays “FJ carbonated drink” (product name) and “120 yen” (price) on the display section 501 (refer to FIG. 6) of the electronic shelf tag 500₁ shown in FIG. 5, thereafter, returns to a main routine shown in FIG. 10.

When the inventory tracking is performed for each electronic shelf tag, the salesclerk presses down, for example, the inventory tracking key 502 (refer to FIG. 6) of the electronic shelf tag 500₁ shown in FIG. 5. Thereby, the control section 303 sets the determination result in step SA3 shown in FIG. 10 to “Yes”. In step SA5, the control section 303 performs inventory tracking processing for each electronic shelf tag with respect to the electronic shelf tag 500₁ (shelf 1) shown in FIG. 5.

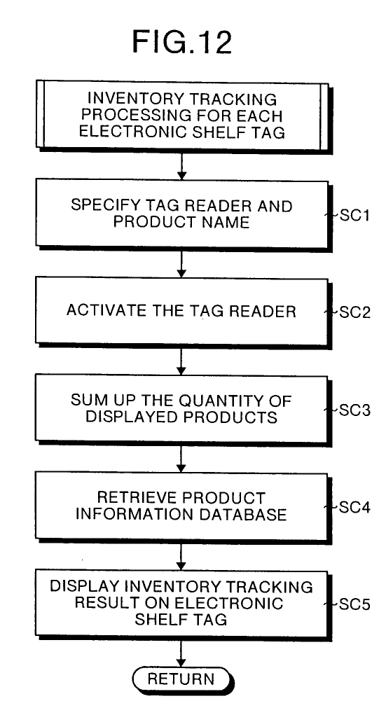

Specifically, in step SC1 shown in FIG. 12, the control section 303 retrieves a tag reader number 001 from the shelf management information database 306 shown in FIG. 4 with the electronic shelf tag number 0001 of the above electronic shelf tag 500₁ as the key, and specifies the corresponding tag reader 800₁ (refer to FIG. 5).

The control section 303 retrieves the product name (FJ carbonated drink) from the product information database 305 shown in FIG. 3 with the shelf number (refer to FIG. 4) corresponding to the above electronic shelf tag number 0001 as the key, and specifies a product to be inventory-tracked.

In step SC2, the control section 303 activates the tag reader 800₁ shown in FIG. 8. Thereby, the transmitting section 802 and the receiving section 803 are operated by the control section 801, and the super tag data 710 (refer to FIG. 9) is read out from the super tags 700₁ to 700₁₀ shown in FIG. 5, respectively. Actually, the super tag data 710 can be also read out from other super tags than the super tags 700₁ to 700₁₀, and the super tag data 710 is filtered in the control section 303 with the product name as the key.

In step SC3 shown in step S12, the control section 303 sums up the quantity of displayed products (FJ carbonated drink) from the super tag data 710 (refer to FIG. 9) received from the respective super tags 700₁ to 700₁₀ shown in FIG. 5, and stores data of the quantity of displayed products into the product information database 305 (refer to FIG. 3).

In an example shown in FIG. 5, the following summing result is obtained.

Shelf number: 1

Product name: FJ carbonated drink

Quantity of displayed products: 10

In step SC4, the control section 303 retrieves the quantity of purchases from the product information database 305 shown in FIG. 3 with the shelf number (or product name) as the key. In step SC5, the control section 303 sets the summing result in step SC3 and the retrieval result in step SC 4 as the inventory tracking result, and displays the inventory tracking result (product name, quantity of purchases, quantity of displayed products) on the display section 501 of the electronic shelf tag 500₁, thereafter, returns to the main routine shown in FIG. 10.

As described above, according to the embodiment, the super tag data is read out from the super tags 700₁ to 700_{d+4} attached to the respective products displayed on the shelves 1 to 5 shown in FIG. 5, and the quantity of products displayed on the shelves is obtained on the basis of this super tag data, so that inventory tracking can be rapidly and accurately performed.

According to the embodiment, the electronic shelf tag 500₁ shown in FIG. 6 is provided in the shelf, inventory tracking for each shelf is performed with the operation of the inventory tracking key 502 as a trigger, and the inventory tracking result is displayed on the display section 501, so that the inventory tracking work can be performed along with another work by the shelf and convenience can be enhanced.

According to the embodiment, as shown in FIG. 15, since the inventory tracking is performed by comparing the quantity of purchases (the logic quantity) and the quantity of displayed products, restock management of products can also be performed rapidly and accurately.

The embodiment according to the present invention is described in detail with reference to the drawings, but a specific configuration example is not limited to this embodiment, and design modifications in the scope without departing from the spirit of the present invention are included in the present invention.

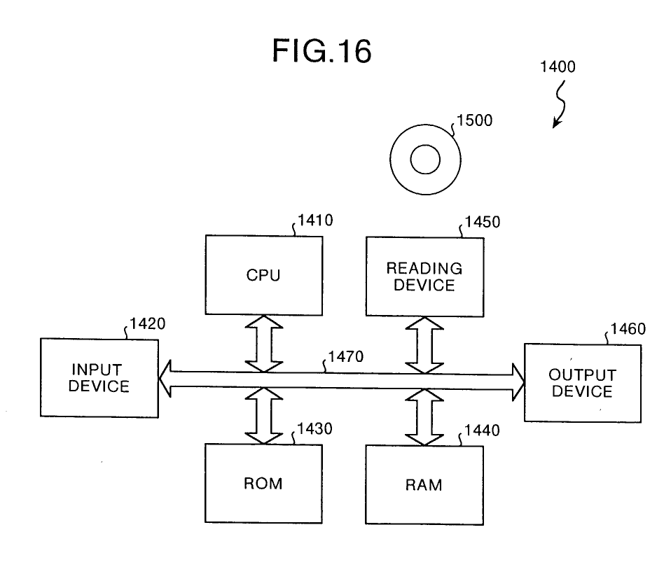

For example, in the aforementioned embodiment, the functions of the electronic shelf management device 300 may be realized by recording a program for realizing the functions of the electronic shelf management device 300 into a computer readable recording medium 1500 shown in FIG. 16 and causing the computer 1400 shown in FIG. 16 to read out and execute the computer program recorded in this recording medium 1500.

The computer 1400 shown in FIG. 16 is configured with a CPU (Central Processing Unit) 1410 for executing the computer program, an input device 1420 such as a keyboard, a mouse or the like, a ROM (Read Only Memory) 1430 for having various data stored therein, a RAM (Random Access Memory) 1440 for having arithmetic parameter and the like stored therein, a reading device 1450 for reading a program from the recording medium 1500, an output device 1460 such as a display, a printer, or the like, and a bus 1470 for connecting the respective sections of the device.

The CPU 1410 executes the computer program after reading the program recorded in the recording medium 1500 via the reading device 1450, thereby realizes the aforementioned functions. The recording medium 1500 includes an optical disk, a flexible disk, a hard disk, and the like.

As described above, according to the present invention, the product information is read out from the tag holding the product information attached to each product displayed on the shelves and the quantity of products displayed on the shelves is obtained on the basis of this product information, so that the inventory tracking can be rapidly and accurately performed.

Moreover, the electronic shelf tag is provided in the shelf, the inventory tracking for each shelf is performed with the operation of the inventory tracking key as a trigger and the inventory tracking result is displayed on the display section, so that the inventory tracking work can be performed along with another work by the shelf and convenience can be enhanced.

Furthermore, since the inventory tracking is performed by comparing the logic quantity of products and the quantity of displayed products, restock management of products can also be performed rapidly and accurately.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A shelf inventory tracking device comprising:
a reading unit which reads out a tag attached to each product displayed on a shelf, the tag holding therein a product information relating to the corresponding product;
a control unit which performs inventory tracking by obtaining the quantity of products displayed on the shelf from the product information read out by the reading unit.

2. The shelf inventory tracking device according to claim 1 further comprising an electronic shelf tag arranged on the shelf, the electronic shelf tag having an inventory tracking key and a display section, wherein the control unit performs inventory tracking for each shelf when the inventory tracking key is operated, and causes the display section to display an inventory tracking result.

3. The shelf inventory tracking device according to claim 1, wherein the control unit performs inventory tracking by comparing the logical quantity of products and the quantity of displayed products.

4. A shelf inventory tracking method comprising:
reading product information from a tag that is attached to each product displayed on a shelf; and
performing inventory tracking by obtaining the quantity of products displayed on the shelf from the read product information.

5. A shelf inventory tracking program for causing a computer to function as a control unit which performs inventory tracking by obtaining the quantity of products displayed on a shelf on the basis of product information read out by a reading unit which reads out the product information from a tag holding the product information attached to each product displayed on the shelf.
